(19) United States
(12) Patent Application Publication
(10) Pub. No.: US 2010/0226471 A1
(43) Pub. Date: Sep. 9, 2010

(54) SYSTEM FOR EVACUATING THE RESIDUAL HEAT FROM A LIQUID METAL OR MOLTEN SALTS COOLED NUCLEAR REACTOR

(75) Inventor: Luciano Cinotti, Recco (IT)

Correspondence Address: The Belles Group, P.C., 1518 Walnut Street, Suite 1706, Philadephia, PA, 19102, US

(73) Assignee: DEL NOVA VIS S.R.L., Milano (IT)

(21) Appl. No.: 12/596,094

(22) PCT Filed: Apr. 15, 2008
(86) PCT No.: PCT/IB2008/000907

§ 371 Date: May 5, 2010

(30) Foreign Application Priority Data
Apr. 16, 2007 (IT) MI2007A000773

(51) Int. Cl. G21C 15/18

(52) U.S. Cl. 376/299

(57) ABSTRACT

A system for evacuating the residual heat from a nuclear reactor cooled with liquid metal or molten salts has two types of heat exchangers immersed in the primary fluid of the reactor: heat exchangers with higher power density, which use boiling water as secondary cooling fluid and are particularly suitable for evacuating the residual heat in the first days after turning-off of the reactor; and heat exchangers operating with atmospheric air or with water and suitable for evacuating the residual heat for indefinite periods of time. Both types of heat exchangers present a bundle of heat-exchange elements, shaped in such a way that the secondary fluid circulating in each element is separated from the primary fluid of the reactor by a double wall of the element, which delimits a gap introduced in which is a pressurized inert gas having the function of continuous monitoring of the integrity of the heat exchanger and of thermal resistance calibrated for preventing solidification of the primary fluid of the reactor in the heat exchanger.

### TECHNICAL FIELD

The present invention relates to a system for evacuating the residual heat from a liquid metal or molten salts cooled nuclear reactor.

### BACKGROUND ART

It is known that in nuclear reactors there exists the need to evacuate the residual heat after stopping the reactor. For reasons of safety, the systems for evacuation of the residual heat must be particularly reliable and preferably diversified.

In nuclear reactors that use water as primary cooling fluid, it is natural to use water also for the residual heat evacuation circuit, whilst for reactors that use primary cooling fluids other than water, in particular liquid metals or molten salts, the use of water is rendered problematical on account of the incompatibility between the two fluids, as in the case of sodium-cooled reactors, or of the risk of solidification of the primary fluid, as in general occurs in reactors cooled with liquid metal or molten salts.

Consequently, auxiliary circuits operating with liquid metals or molten salts are used, which are, however, according to the known solutions, very costly and not fully satisfactory in terms of reliability.

### DISCLOSURE OF INVENTION

An object of the present invention is to provide a system for evacuation of the residual heat from a nuclear reactor aimed at improving the known solutions, eliminating or reducing the drawbacks thereof.

The present invention hence relates to a system for evacuation of the residual heat from a nuclear reactor, in particular a liquid metal or molten salts cooled nuclear reactor, as defined in essential terms in the annexed Claim 1 and, as regards its preferred characteristics, in the dependent claims.

### BRIEF DESCRIPTION OF THE DRAWINGS

The invention is described by way of example in the following non-limiting embodiments, with reference to the figures of the annexed drawings, wherein:

FIG. 1 is a schematic view of a nuclear reactor provided with a system for evacuation of the residual heat in accordance with the invention;

FIG. 2 is a schematic view in longitudinal section of a heat exchanger forming part of the system of FIG. 1;

FIGS. 3-4 are views sectioned, respectively, according to the planes of trace and IV-IV of FIG. 2;

FIG. 5 is a schematic view in longitudinal section of a variant of the heat exchanger of FIG. 2;

FIG. 6 is a schematic view in longitudinal section of a further heat exchanger forming part of the system of FIG. 1; and

FIGS. 7-8 are views sectioned respectively according to the planes of trace VII-VII and VIII-VIII of FIG. 6.

### BEST MODE FOR CARRYING OUT THE INVENTION

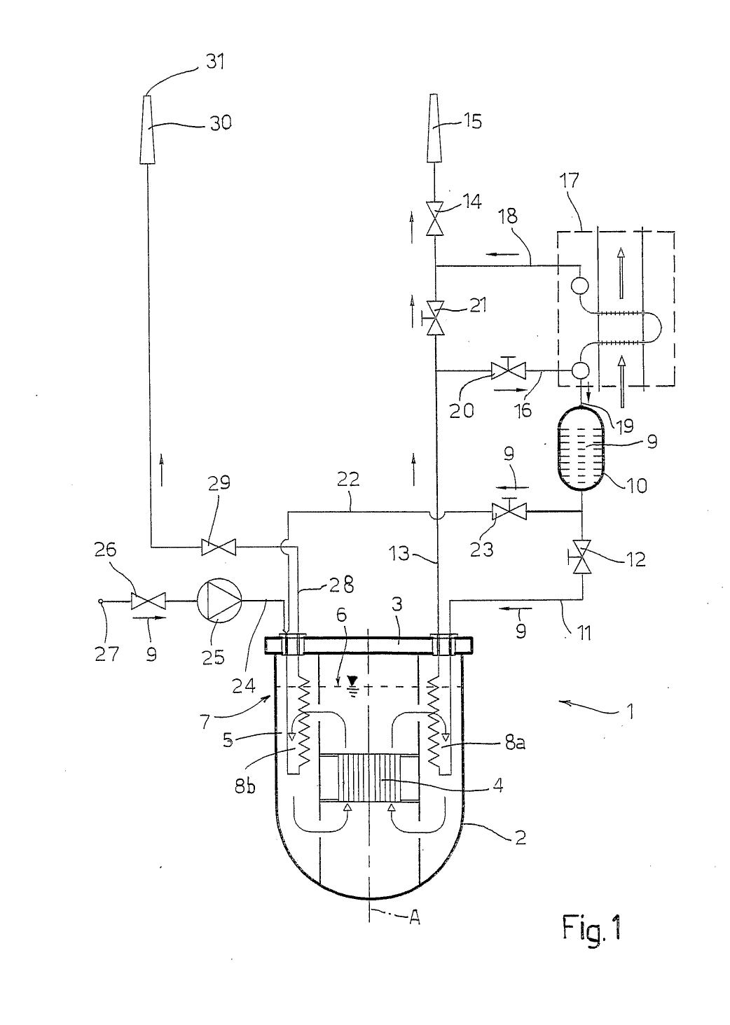

With reference to FIG. 1, a nuclear reactor 1 of a substantially known type, in particular a reactor using liquid metal or molten salts as primary cooling fluid, comprises a tank 2, which extends around a central axis A and is covered by a roof 3. Arranged within the tank 2 is a core 4, cooled by a primary fluid 5 (constituted, for example, by sodium, lead, lead-bismuth eutectic or molten salts), which fills the tank 2 up to a given height of the surface 6 of the fluid. Likewise housed in the tank 2 are primary heat exchangers, which transfer the power generated in the core 4 to a secondary circuit, as well as circulation pumps, machines for transfer of the fuel, and structures for supporting the instrumentation and control bars, none of which is represented in so far as they are not pertinent to the present invention.

The reactor 1 is provided with a system 7 for evacuation of the residual heat, comprising heat exchangers 8 housed circumferentially in the tank 2 and co-operating with the primary fluid 5 for transferring heat from the primary fluid 5 to a secondary cooling fluid 9 circulating in the heat exchangers 8. In particular, the system 7 comprises two types of heat exchangers 8:
one or more heat exchangers 8a, with higher power density, which use boiling water as secondary cooling fluid 9 and are particularly suitable for evacuating the residual heat in the first days after turning-off of the reactor 1; and
one or more heat exchangers 8b capable of operating in atmospheric air or in water or with air/water combined operation, which are suitable for evacuating the residual heat for indefinite periods of time.

The heat exchanger 8a, which operates with water as secondary fluid 9, is connected to a reservoir 10, set at a greater height than the heat exchanger 8a, via a supply duct 11 provided with a valve 12 (or a system of valves) for water supply. The heat exchanger 8a is also connected, via a discharge pipe 13 set on which is a discharge valve 14, to a discharge 15 (possibly associated to a stack) towards the outside environment.

Fitted on the discharge pipe 13, via a branching, is a recovery circuit 16 connected to a condenser 17, of a known type and preferably with finned tubes, set at a greater height than the reservoir 10. The condenser 17 is connected via a non-condensable discharge duct 18 to the discharge pipe 13, and to the reservoir 10 via a duct 19 for recirculation of the condensed water. The fraction of vapour to be sent to the condenser 17 can be adjusted, for example, by acting on valves 20, 21 arranged respectively along the recovery circuit 16 and along the discharge pipe 13 downstream of the branching of the recovery circuit 16.

The heat exchanger 8b, which is able to operate with water or air as secondary fluid 9, is connected to the reservoir 10 via a connection circuit 22 provided with a valve 23 (or a system of valves). The heat exchanger 8b is moreover connected, via a duct 24 provided with a motor-ventilator 25 and a gate valve 26, to an external-air intake 27, and, via a discharge pipe 28 provided with a gate valve 29, to a stack 30 having an external outlet 31 for discharge of air and/or vapour.

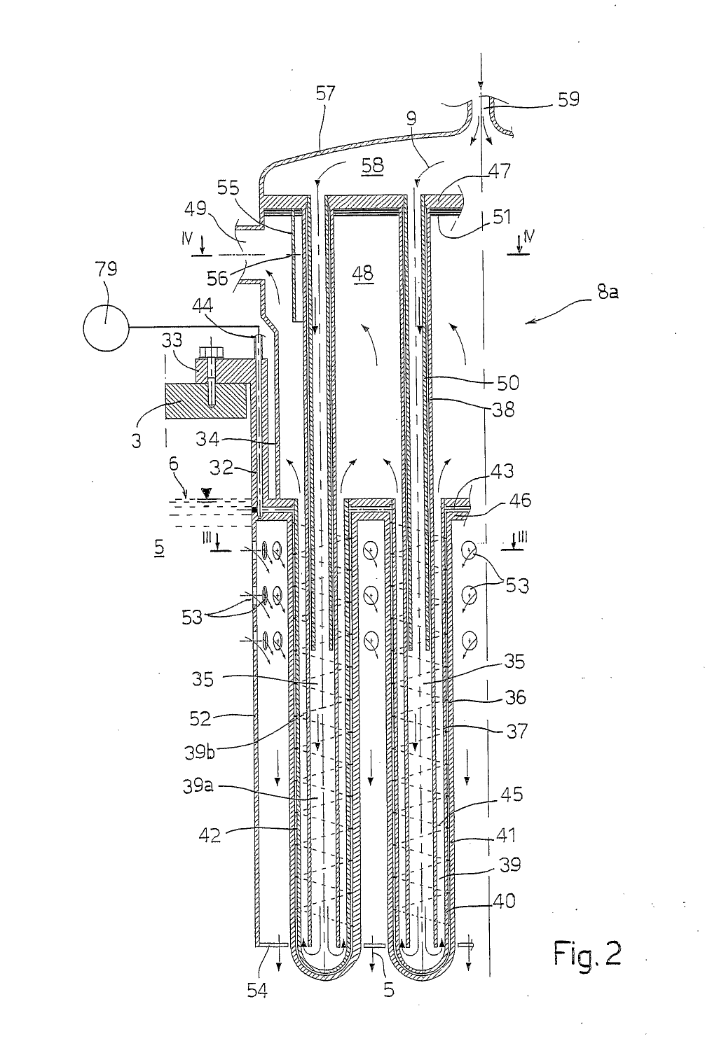

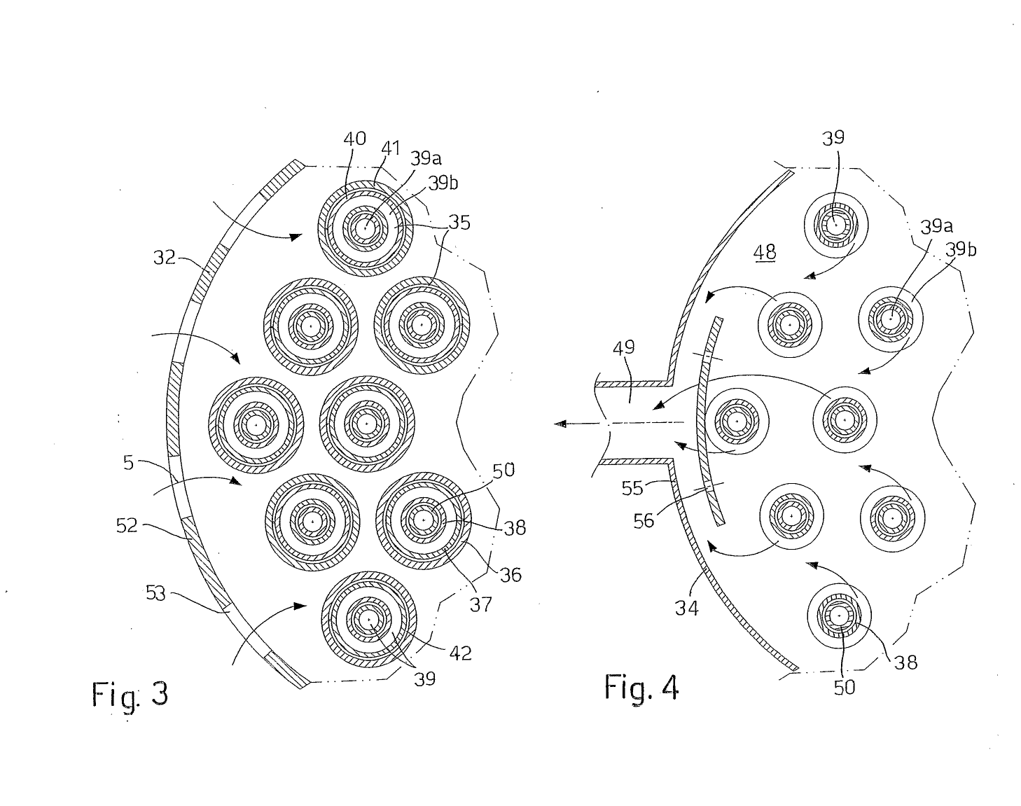

With reference to FIGS. 2-4, the heat exchanger 8a comprises a supporting structure 32, which is set so as to pass through a seat formed in the roof 3 and fixed in a fluid-tight way, via a flange 33, to the roof 3. The structure 32 is provided on the inside with a top conveying structure 34, for example, constituted by a substantially cylindrical ferrule; the structure 32 extends vertically downwards in the primary fluid 5 and houses a bundle of heat-exchange elements 35 in which the secondary fluid 9 circulates.

In the preferred embodiment shown, the heat exchanger 8a comprises a bundle of elements 35 with bayonet tubes. Each element 35 comprises at least three substantially vertical and substantially co-axial tubes 36, 37, 38, inserted inside one another and spaced radially apart from one another.

In particular, each element 35 comprises a central inner tube with open end that conveys cold secondary fluid 9 downwards, an intermediate tube 37 set around the tube 38 and defining with the tube 38 a return channel for the hot secondary fluid 9, and an outer tube 36 set around the tube 37. Each element 35 hence comprises an internal duct 39, having a wall 40 and circulating in which is secondary fluid 9, and an external wall 41, which surrounds at least one stretch of the internal duct 39 immersed in the primary fluid and delimits with the wall 40 a gap 42. In the case in point, the internal duct 39 comprises a delivery channel 39a defined within the tube 38, and a return channel 39a delimited between the tube 37 and the tube 38. The walls 40, 41 are constituted by respective portions of side walls of the tube 37 and of the tube 36; the gap 42 is defined between the tube and the tube 37. In this way, the primary fluid 5 is separated from the secondary fluid 9 (and hence from the environment outside the reactor 1) by a double wall constituted by the walls 40, 41 and defining a double barrier between the primary fluid 5 and the outside environment.

An interstitial fluid, preferably high-conductivity inert gas, for example helium, is contained in the gap 42 at a pressure higher than the pressure of the primary fluid 5 set on the outside of the elements 35 and at the pressure of the secondary fluid 9 circulating inside the elements 35. A circuit 43 hydraulically connects the gaps 42 of the various elements 35 to one another and to an external gas outlet 44 (set on the outside of the reactor 1).

The outer tube 36 and the intermediate tube 37 of each element 35 are set at a distance from one another and maintained co-axial, in order to guarantee a uniform width of the gap 42, by means of spacer elements 45, for example, constituted by one or more wires wound in a helix around the tube 37 and set between the tube 37 and the tube 36.

The heat exchanger 8a comprises a bottom tube plate 46, which is connected to the structure 32 substantially in a position corresponding to the surface 6 of the fluid and carries the tubes 36 and the tubes 37, and a top tube plate 47, set on the outside of the reactor 1, which carries the tubes 38. The plates 46, 47 delimit, together with the conveying structure 34, a hot header 48 provided with an outlet 49 connected to the discharge pipe 13.

Branching off from the top plate 47 are the tubes 38, which are inserted at the bottom within the tubes 37, and a plurality of auxiliary tubes 50 set co-axial and concentric inside respective tubes 38; the tubes 38 extend as far as in the proximity of the closed end of the tubes 37, whilst the tubes 50 can even be shorter, i.e., penetrate only for a given length within the tubes 37.

The plate 47 is thermally shielded at the bottom by an insulating structure 51, preferably of a metal type.

The bundle of elements 35, and specifically the tubes 36, 37, are contained within a ferrule 52, which is, for example, substantially cylindrical and extends at the bottom from the plate 46; the ferrule 52 has top openings 53 in the proximity of the plate 46 and is open at the bottom or in any case has a bottom opening 54 for enabling inlet and outlet of the primary fluid 5 to be cooled. A shield 55, possibly provided with holes 56, extends from the plate 47 into the header 48 in a position corresponding to the outlet 49 for reducing the fluid-induced vibrations in the tubes 38 set close to the outlet 49. The plate 47 delimits, together with a top lid 57, a cold header 58 provided with a supply mouthpiece 59 fitted on which is the duct 11.

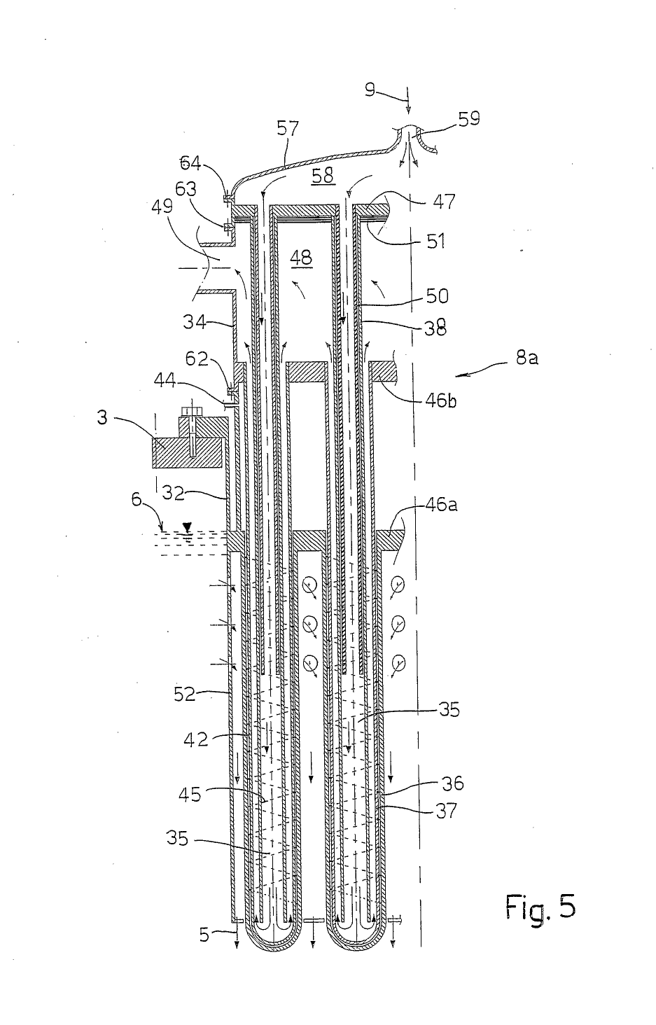

In the variant of FIG. 5, in which items that are similar to or the same as the ones already described are designated by the same reference numbers, the heat exchanger 8a comprises, instead of a single plate 46 that carries the outer tubes 36 and the intermediate tubes 37, a pair of bottom tube plates 46a, 46b, which carry the outer tubes 36 and the intermediate tubes 37, respectively. The plate 46a is always set substantially at the level of the surface 6 of the fluid, whilst the plate 46b is set in an intermediate region between the plate 46a and the top plate 47 that carries the inner tubes 38 and the auxiliary tubes 50.

The plate 46b is provided with a releasable bottom flanged coupling 62, which enables extraction/introduction of the tubes 37 from/into the tubes 36. The plate 47 is provided with: a releasable bottom flanged coupling 63, which enables extraction/introduction of the tubes 38 and 50 from/into the tubes 37; and/or a releasable top flanged coupling 64, which makes it possible to open the header 58 (which again is set between the plate 47 and the lid 57) and gain access to the inside of the tubes 38 and 50.

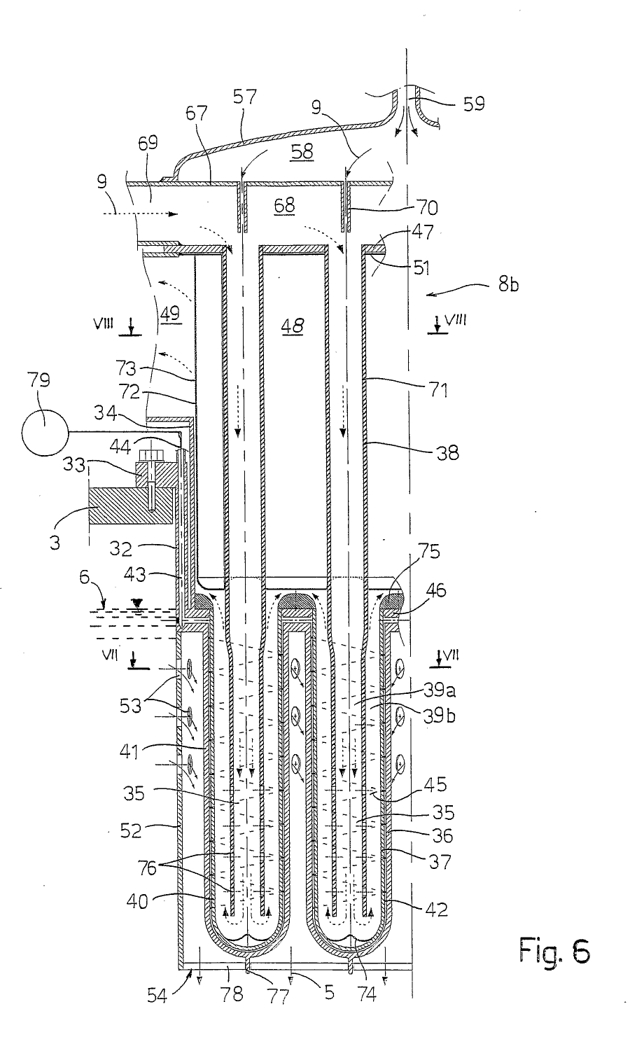

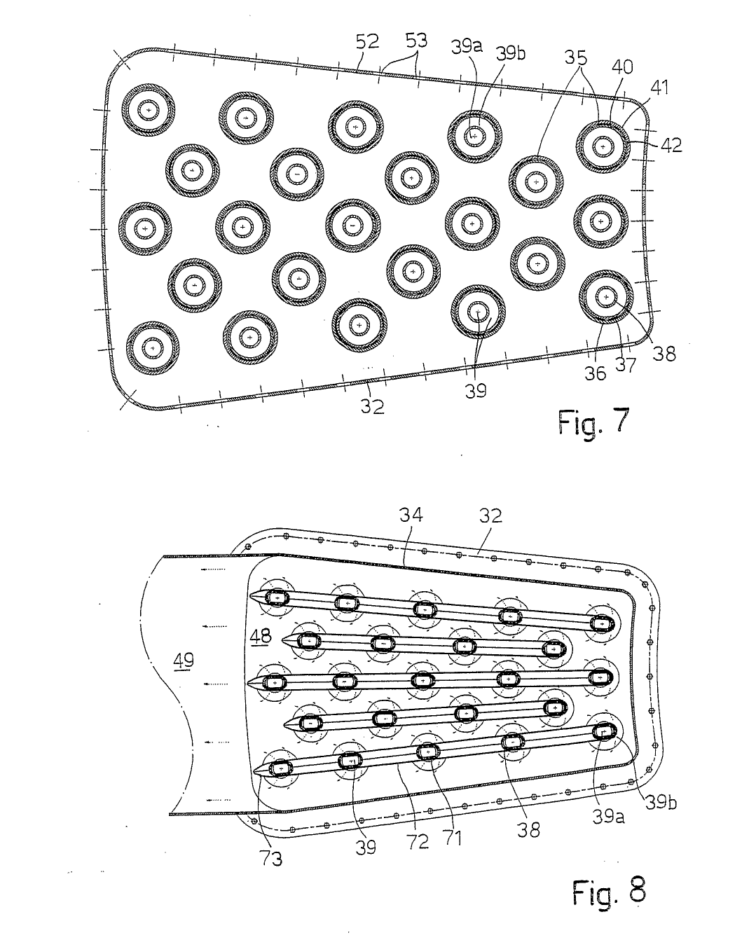

FIGS. 6-8 show the heat exchanger 8b. In these figures, items that are similar to or the same as the ones already described with reference to the heat exchanger 8a are designated by the same numbers. The heat exchanger 8b has, in fact, a general configuration similar to that of the heat exchanger 8a so that only the main differences that it has with respect to the heat exchanger 8a are described in detail.

Also the heat exchanger 8b comprises a containment structure 32, which houses a bundle of heat-exchange elements 35, preferably with bayonet tubes, which extend in a substantially vertical direction and are at least partially immersed in the primary fluid 5. Each element 35 also comprises a pair of co-axial tubes 36, 37 with closed end, delimiting the gap 42 and set at a distance from one another by spacer elements 45, and an central inner tube 38 with open end, which is inserted at the bottom within the tube 37 as far as in the proximity of the end of the tube 37.

The structure 32 comprises a bottom plate 46, branching off from which at the bottom are the tubes 36 and 37, a top plate 47 that carries the tubes 38, and a further head tube plate 67 set at a greater height than the plate 47 between the plate 47 and the lid 57. Within the structure 32, the plates 46, 47 delimit (together with a conveying structure 34) the hot header 48, provided with an outlet 49. The plate 67 and the lid 57 delimit a first cold header 58, provided with a cold-water supply mouthpiece 59, connected, via the circuit 22, to the reservoir 10. The plates 47, 67 delimit a second cold header 68, provided with a cold-air supply mouthpiece 69, connected to the duct 24.

Branching off from the plate 67 inside the header 68 are small water-inlet tubes 70, set in a position corresponding to and aligned with respective tubes 38.

The tubes 38 normally have a circular cross section, but can have respective top stretches 71, set on the outside of the tubes 37, slightly flattened, i.e., with a cross section of an elongated shape, for example substantially elliptical or the like.

The plate 47 carries an insulating structure 51, set on a bottom face of the plate 47, and heat-insulating structures 72, arranged substantially vertical around respective aligned arrays of tubes 38 with function of thermal, shield of the top part of the tubes 38 themselves. The insulating structures 72 are appropriately pointed or wedge-shaped in the proximity of the outlet 49. In particular, they present terminal portions that are tapered towards the outlet 49, to constitute also stream-guide structures 73 and reduce the head losses.

Flow deviators 74, 75 are set, respectively, at the bottom end of the tubes 37 and in a bottom area of the header 48 for reducing the head losses of the flow of air at outlet from the tubes 38 and at outlet from the return channels 39b. Optionally, the tubes 38 are provided on respective bottom-end stretches with radial holes 76.

The tubes 36 are provided with respective knobs 77 that extend axially from a bottom end of the tubes 36 and are inserted in a grid 78 carried by a bottom end of the structure 32, which renders the elements 35 fixed with respect to one another. The internal surfaces of the tubes 37 and the external surfaces of the tubes 38, at least in the stretches inserted within the tubes 37, are painted with high-emissivity paint.

The ferrule 52 that houses the elements 35 and conveys the primary fluid 5 to be cooled so that it laps the elements 35 is not indispensable and in certain constructional-applications, especially with elements 35 of large diameter, may be omitted.

Since the heat exchanger 8b operating with air generally entails considerable overall dimensions, it is advisable for the cross section of the heat exchanger 8b to be designed exploiting to the utmost the space available within the tank 2, which is normally constituted by an annular space comprised between the tank 2 and the core 4. The heat exchanger 8b, and specifically its structure 32, hence have a substantially trapezoidal cross section with a major base set towards the outside of the reactor 1, its minor base set towards the inside, and the convergent sides towards the central axis A of the reactor 1. This geometry moreover enables the elements 35 to be set at a greater distance apart in the proximity of the outlet 49 in order to decrease locally the rate of the air and consequently the head losses.

Operation of the system 7 is described in what follows.

During normal operation of the reactor 1, the valve 12 for water supply is closed and the discharge valve 14 is open. The gaps 42 of the elements 35 of the heat exchanger 8a are pressurized at a pressure higher than the pressure of the primary fluid 5 in a region corresponding to the bottom of the elements 35, as well as the pressure of the secondary fluid 9 circulating in the elements 35.

Continuous monitoring of the mechanical integrity of the elements 35 is ensured by the fact that a failure of a tube 36 or of a tube 37 can be detected from a reduction in pressure in the gap 42 and hence in the circuit 43. For said purpose, means 79 are envisaged for monitoring and controlling the pressure of the interstitial fluid in the gap 42 (known and indicated only schematically in FIG. 2).

Upon stopping of the reactor 1, in order to evacuate the residual heat the system 7 goes into operation, and specifically the heat exchanger 8a. With opening the valve 12 the water flows out by gravity from the reservoir 10 into the duct 11 and then, through the supply mouthpiece 59, into the cold header 58, from which it is distributed into the various elements 35. In each element 35, the water circulates in the tubes 38, 50 (i.e., in the delivery channel 39a of the internal duct 39) to reach the bottom of the element 35 and rise boiling (passing into the vapour phase) through the return channel 39a delimited between the tubes 37 and 38 as far as the hot header 48. The vapour then flows through the outlet 49 into the discharge pipe 13 and is discharged into the external atmosphere via the discharge outlet 15. The tubes 50, which are of a relatively small diameter and hence present a high loss of head of the water, contribute to the hydraulic stability of the system 7 during its operation.

The flowrate of water through the valve 12 can be adjusted in such a way as to control the temperature of the vapour produced, preferably super-heated for reducing water consumption. The water consumption can also be reduced by means of the condenser 17, which, cooled by natural circulation of air, condenses a part of the vapour, which returns into the reservoir 10. By adjusting the pressure of the vapour via the valve 14 to a pressure higher than atmospheric pressure, it is possible to increase the performance of the condenser 17. By possibly acting on the valves 20, 21, it is also possible to adjust the flowrate to be sent to the condenser 17 in such a way as to optimize the performance. Since the power of decay reduces in time, if the power of the condenser 17 exceeds the power of decay before exhaustion of the water, operation of the system 7 is ensured for an indeterminate period.

Boiling of the water in the return channel 39a cools the tubes 36, 37, which, in turn, cool the primary fluid 5 that flows in natural circulation on the outside of the elements 35 from the top downwards and laps the elements 35 on the outside and specifically the outer walls 41, penetrating hot into the ferrule 52 via the openings 53 and coming out cooled from the opening 54.

Given that the secondary fluid 9 (water) is at a temperature lower than that of solidification of the primary fluid 5, in order to prevent solidification of the primary fluid 5, the thickness of the gap 42 is determined, according to the invention, in such a way that the temperature of the external wall 41 in contact with the primary fluid 5 will have, in use, in each point, a temperature higher than the temperature of solidification of the primary fluid 5.

In the hot header 48, the water circulates in the tubes 50 that define a structure for thermal insulation of the tubes 38 in order to reduce the thermal bridge between the cold water inside the tubes 50 and the hot vapour in the header 48. In this way, efficiency of the heat exchanger 8a is improved and water consumption is reduced. In the bottom part of the elements 35, at the height at which in the return channel 39a the vapour is not yet super-heated, said thermal bridge is unable to reduce the water consumption, and consequently the tube 50 can be interrupted and the water can flow directly within the tube 38.

The elements 35 constitute a continuously monitored double barrier between the primary fluid and the outside environment. In the (unlikely) case of severe accident with failure of both of the barriers, closing of the valve 14 enables in any case restoration of a barrier between the primary fluid of the reactor and the external environment.

Likewise, also the heat exchanger 8b is set in operation upon stopping of the reactor 1 for evacuating the residual heat.

Opening of the gate valves 26 and 29, thanks to the drought of the flue of the stack 30 enables operation in natural circulation of air, which enters the heat exchanger 8b via the duct 24 and via the supply mouthpiece 69, descends in the tubes 38, and rises in the return channel 39a. Heating of the air occurs by thermal exchange with the internal and external surfaces of the tubes 38 and with the internal surface of the tubes 37. The tubes 38 are heated by irradiation from the internal surface of the tubes 37. Possible intervention of the motor-driven fans 25 increases the flow of cooling air and increases the power exchanged.

In the case where it is necessary to increase the performance of the system 7 and specifically of the heat exchanger 8b, it is also possible to resort to water cooling, causing water to flow into the heat exchanger 8b by opening the valve 23 on the circuit 22 for connection between the reservoir 10 and the heat exchanger 8b.

Since for the heat exchanger 8b it is very important to reduce the head loss on the air side, various constructional solutions may be adopted for minimizing it, such as the flow deviators 74, 75 within the elements 35 and at the output of the inner tubes 39, the flattened stretches 71 of the tubes 38 set on the outside of the tubes 37, and the vein-guide structures 73.

The holes 76, appropriately sized according to the operating conditions of the system 7, enable a combined air/water operation intended to prevent reflux of vapour back to the duct 24 and reduce the water consumption in combined operation.

Finally, it is understood that numerous modifications and variations may be made to the system described and illustrated herein, without thereby departing from the sphere of protection of the annexed claims.

For example, internal ducts 39 can be used having a different geometry from the ones described herein by way of example; the constructional solution described, which is based upon bayonet tubes with elements 35 constituted by at least three concentric tubes, presents, however, the advantage of absorbing easily big temperature differences between the intermediate tube 37 and outer tube 36, which are free to expand axially with respect to one another.

1. A system (7) for evacuating the residual heat from a nuclear reactor (1) cooled by a primary fluid (5), in particular liquid metal or molten salts, the system comprising at least one heat exchanger (8) having a plurality of heat-exchange elements (35) co-operating with the primary fluid for transferring heat from the primary fluid to a secondary cooling fluid (9) circulating in the elements; the system being characterized in that the secondary fluid (9) circulating in each element (35) is separated from the primary fluid (5) by a double wall (40, 41) of the element (35) delimiting a gap (42) inserted in which is a pressurized inert interstitial fluid.

2. A system according to claim 1, wherein the secondary fluid (9) is water or air.

3. A system according to claim 1 or claim 2, wherein the interstitial fluid is a high thermal conductivity inert gas.

4. A system according to any one of the preceding claims, wherein the gap (42) contains interstitial fluid at a pressure higher than the pressure of the primary fluid (5) outside the elements (35) and than the pressure of the secondary fluid (9) circulating inside the elements (35).

5. A system according to any one of the preceding claims, wherein the thickness of the gap (42) is such that an external wall (41) of the element (35) in contact with the primary fluid (5) has, in use, in each point of the element (35), a temperature higher than the temperature of solidification of the primary fluid (5).

6. A system according to any one of the preceding claims, further comprising means (79) for monitoring and controlling the pressure of the interstitial fluid in the gap (42).

7. A system according to any one of the preceding claims, wherein each element (35) comprises an internal duct (39), in which secondary fluid (9) circulates, and an external wall (41), which surrounds at least one stretch of the internal duct (39) immersed in the primary fluid (5) and delimits with the internal duct the gap (42).

8. A system according to any one of the preceding claims, wherein each element (35) comprises at least three tubes (36, 37, 38), which are substantially vertical and substantially co-axial to one another, which are inserted inside one another and are radially spaced apart from one another.

9. A system according to claim 8, wherein each element (35) comprises a central inner tube (38) with an open end that conveys downwards a secondary cold fluid, an intermediate tube (37), set around the inner tube (38) and defining with the inner tube (38) a return channel (39b) for hot secondary fluid, and an outer tube (36), set around the intermediate tube (37) and defining with the intermediate tube (37) the gap (42) introduced in which is the interstitial fluid.

10. A system according to claim 9, wherein the outer tube (36) and the intermediate tube (37) of each element (35) are spaced apart from one another and maintained co-axial by means of spacer elements (45).

11. A system according to claim 10, wherein the spacer elements (45) comprise at least one wire spirally wound around the intermediate tube (37) and interposed between the intermediate tube (37) and the outer tube (36).

12. A system according to any one of claims 9 to 11, wherein the heat exchanger (8) comprises a hot header (48) connected to the return channels (39b) for the hot secondary fluid and crossed by the inner tubes (38) in which the cold secondary fluid circulates; the inner tubes (38) being shielded, at least on respective stretches inserted in the hot header (48), by heat-insulating structures (50; 72).

13. A system according to any one of claims 9 to 12, wherein the inner tubes (38) are provided, on respective bottom-end stretches, with radial holes (76).

14. A system according to any one of claims 9 to 13, wherein the heat exchanger (8) comprises a top tube plate (47) that carries the inner tubes (38) and is shielded at the bottom by an insulating structure (51).

15. A system according to claim 14, wherein the top tube plate (47) is provided with: a releasable bottom flanged coupling (63), which enables the extraction of the inner tubes (38) from the intermediate tubes (37); and/or a releasable top flanged coupling (64), which makes it possible to open a cold header (58) of the heat exchanger (8) and gain access to the inside of the inner tubes (38).

16. A system according to any one of claims 9 to 15, wherein the heat exchanger (8) comprises a bottom tube plate (46), which carries the outer tubes (36) and the intermediate tubes (37), or else a pair of bottom tube plates (46a, 46b), which carry the outer tubes (36) and the intermediate tubes (37), respectively.

17. A system according to any one of the preceding claims, comprising at least one heat exchanger (8b) supplied with external atmospheric air circulating by natural draught by means of a stack (30) and/or by forced circulation by means of a motor-driven fan (25).

18. A system according to any one of the preceding claims, comprising at least one heat exchanger (8) which is supplied with water circulating by gravity from a reservoir (10) set at a greater height than the heat exchanger (8), and which discharges vapour, preferably super-heated vapour, onto the outside via a discharge pipe (13; 28).

19. A system according to claim 18, wherein the discharge pipe (13) is connected to a recovery circuit (16) for intercepting and condensing the vapour and recirculating the condensate.

20. A system according to any one of the preceding claims, comprising at least one heat exchanger (8a) operating with water and at least one heat exchanger (8b) operating with water and/or air.
